(19) United States
(12) Patent Application Publication
(10) Pub. No.: US 2026/0126089 A1
(43) Pub. Date: May 7, 2026

(54) Multipart Brake Disc, Friction Disc Ring Part, Securing Element, and Method for Producing a Brake Disc

(71) Applicant: GOTEC GORSCHLÜTER GMBH, Wülfrath (DE)

(72) Inventors: Lars GORSCHLÜTER, Wülfrath (DE); Jörg GORSCHLÜTER, Wülfrath (DE); Felix SCHULTE, Wülfrath (DE)

(21) Appl. No.: 18/874,798

(22) PCT Filed: Mar. 28, 2024
(86) PCT No.: PCT/DE2024/100269

§ 371 Date: Dec. 13, 2024

(30) Foreign Application Priority Data
Mar. 29, 2023 (DE) 10 2023 108 069.5

(51) Int. Cl. F16D 65/12; F16B 2/00; F16D 65/00; F16D 65/02

(52) U.S. Cl. CPC F16D 65/123; F16B 2/00; F16D 65/0025; F16D 2065/1316; F16D 2065/1328; F16D 2065/1372; F16D 2065/1392; F16D 2200/0021; F16D 2250/0084

(57) ABSTRACT

The invention relates to a multi-part brake disk, in particular a lightweight brake disk, with a friction disk ring part and with a receiving cup part, in which the friction disk ring part is arranged radially on the outside of the receiving cup part in a torque-proof manner, in which the friction disk ring part and the receiving cup part are additionally operatively connected to one another by means of at least one elongate fastening element, whereby the at least one elongate fastening element is arranged in a through-hole of the receiving cup part and in a bore hole in the friction ring part, whereby the multi-part brake disk is characterized in that the at least one elongate fastening element is arranged so as to be merely inserted into both the receiving cup part and the friction disk ring part, whereby the at least one elongate fastening element is arranged in a frictionally locked manner in the friction disk ring part.

The invention relates to a multi-part brake disk, in particular a lightweight brake disk, with a friction disk ring part and with a receiving pot part, in which the friction disk ring part is arranged radially on the outside of the receiving pot part in a torque-proof manner, in which the friction disk ring part and the receiving pot part are additionally operatively connected to one another by means of at least one elongate fastening element, whereby the at least one elongate fastening element is arranged in a through-hole of the receiving pot part and in a hole in the friction ring part.

The invention relates to a friction disk ring part for a multi-part brake disk.

The invention also relates to a fastening element for a multi-part brake disk.

The invention relates to a method of manufacturing a brake disk from several functional parts in which a friction disk ring part with an internal diameter is arranged on a radial externally arranged receiving surface with an external diameter of a receiving pot part.

Generic multi-part brake disks are known from the prior art and can be used, for example, on vehicles, in particular on motor vehicles, such as cars, trucks, or the like. Here, the brake disks can be fastened to wheel hubs of the vehicle with a screw joint. Such brake disks are often made up of several parts, i.e., the brake disks each have a generally cup-shaped receiving part to which the actual friction disk of the brake disk is attached, whereby the friction disk can interact with brake pads of the brake system if necessary, while the cup-shaped receiving part is screwed to the wheel hub of the vehicle axle.

The present invention is based on the objective of providing an improvement or an alternative to the state of the art.

According to a first aspect of the invention, the stated object is achieved by a multi-part brake disk, in particular a lightweight brake disk, with a friction disk ring part and with a receiving pot part, in which the friction disk ring part is arranged radially on the outside of the receiving pot part in a torque-proof manner, in which the friction disk ring part and the receiving pot part are additionally operatively connected to one another by means of at least one elongate fastening element, whereby the at least one elongate fastening element is arranged in a through-hole of the receiving pot part and in a hole in the friction disk ring part, whereby the at least one elongate fastening element is arranged so as to be merely inserted into both the receiving pot part and the friction disk ring part, and whereby the at least one elongate fastening element is arranged in a frictionally locked manner in the friction disk ring part.

Because the fastening element is only inserted into the two functional components, an additional interaction between the functional components friction disk ring part and receiving pot part and the fastening element can be created in an extremely simple construction.

In particular, complex threaded holes in the friction disk ring part and/or in the receiving pot part can be dispensed with in order to hold the fastening element to the brake disk.

In this respect, multi-part brake disks can be manufactured significantly more cost-effectively using the present invention.

Conceptually, the following is explained:

The invention relates to both solid and internally ventilated brake disks.

Here, both several through-holes and several bore holes can be distributed in the circumferential direction of the brake disk and thus also in the circumferential direction of the friction disk ring part or receiving pot part.

In the sense of the invention, the term “bore” refers to any type and shape of openings or holes that extend in a radial direction in the respective functional component.

In particular, the hole can extend as a blind hole or as a continuous hole in the friction disk ring part, for example, also as part of an internal ventilation of a friction disk ring part.

In this respect, the fastening element can be at least partially integrated in a ventilation channel of the friction disk ring part, or can be arranged completely in the solid material of one friction disk half of two friction disk halves of the friction disk ring part.

In the context of the present patent application, “elongate” is to be understood as a pin which has a longitudinal extension, whereby the pin is longer along its longitudinal extension than it is in its transverse extension, in particular by more than 20%, especially more than 30% longer, whereby the transverse extension is preferably its diameter and/or whereby the longitudinal extension can preferably be understood as along a longitudinal axis, especially a rotational symmetry axis, of the fastening element.

While the friction disk ring part is preferably made of a cast material, the receiving pot part preferably consists of a sheet metal construction.

Like the bore hole, the through-hole is preferably designed to be completely thread-free.

In particular, by means of the operative connection described here between the fastening part, the friction disk ring part and the receiving pot part, an axial lock can be realized on the multi-part brake disk, so that an unwanted axial displacement between the friction disk ring part and the receiving pot part along the rotational axis of the multi-part brake disk can be excluded.

The fastening element can be particularly well secured in the friction disk ring part if the at least one elongate fastening element is arranged in the friction disk ring part by means of a press fit connection. A press fit connection can be achieved by simply hammering the fastening element through the through-hole of the receiving pot part into the bore hole in the friction disk ring part.

A further improved connection, in particular between the fastening element and the friction disk ring part, can be achieved if the at least one elongate fastening element is arranged in a form-fitting manner in the friction disk ring part.

In particular, a form-fitting connection can be used to reduce compressive forces that act on the material of the friction disk ring part from the inside when the fastening element is inserted into the friction disk ring part.

In this respect, it is advantageous if the at least one elongate fastening element is arranged in the friction disk part by means of a form-fitting connection.

If the at least one elongate fastening element and the friction disk ring part are at least partially interlocked with one another, unfavorable internal pressure forces in the friction disk ring part can be avoided or at least reduced.

This can be achieved in particular if the fastening element interacts with the friction disk ring part mainly by means of suitable toothing. In other words: Mainly, elevations provided on the jacket surface of the fastening element interact with the material of the friction disk ring part, whereby the forces acting on the material within the hole can be reduced, in particular compared to a fastening element that has a smooth jacket surface.

An advantageous embodiment variant can be provided if the at least one elongate fastening element at least partially has a surface structure on its jacket surface, preferably a directed surface structure.

Because a suitable surface structure is arranged on the outside of the fastening element, a positive fit between the fastening element and the friction disk ring part can be produced in a particularly advantageous manner in the sense of the invention.

A suitable surface structure can be designed in a great variety of ways. The surface structure can be designed particularly simply if the surface structure includes grooves, ridges, or the like.

If the surface structure preferably extends in the longitudinal direction of the elongate fastening element, the fastening element can be introduced with less insertion force, for example, in particular into the friction disk ring part.

### Here, the Surface Structure Can Be Fully or Partly Formed on the Fastening Element.

In any case, the surface structure, in particular the grooves thereof, is preferably designed in such a way that when the friction disk ring part expands radially, the receiving pot part can preferably be moved along with it in the same order of magnitude.

If the at least one elongate fastening element is arranged pressed into the material of the friction disk ring part by means of at least one surface structure, a positive connection can in particular advantageously be provided.

The fastening element can be designed differently within the meaning of the invention, as already explained above.

Preferably, however, the fastening element is designed as a pin element that is fixedly arranged at least in the friction disk element, for example, as a cylindrical pin, grooved pin, rivet pin, dowel pin, or the like.

In this respect, it is advantageous if the at least one elongate fastening element is a pin element.

In particular, a longitudinally slotted pin element is advantageous because this allows an overload protection device to be formed on the fastening element.

In this respect, it makes sense if the fastening element is in the form of a spring pin.

Furthermore, it is advantageous if the at least one elongate fastening element is a hollow pin element. By means of a hollow pin element, additional ventilation, in particular additional internal ventilation, can be easily achieved with regard to the friction disk ring part on the multi-part brake disk.

Of course, the fastening element can also be made of solid material if this is advantageous for a particular application. However, a fastening element made of solid material is considerably heavier, which would disadvantageously increase the rotating masses on a brake disk if the fastening element is made of solid material.

If at least one elongate fastening element is a heavy-duty spring pin (clamping bush), high shear forces can still be safely absorbed by the elongate fastening element.

This also makes it possible to achieve a solid pin character without having to accept the assembly disadvantages of a solid pin.

It has also been shown that the production of the present multi-part brake disk can be further improved if the elongate fastening element has a toothed slot. By means of teeth arranged offset from one another along the toothed slot, additional axial tension can be achieved on the multi-part fastening element. Toothed slotted fastening elements are often also referred to as “Connex spring pins.”

By means of such a toothed slot, high seating strength can be achieved both with respect to the receiving pot part and the friction disk ring part. Such a toothed slot is often also called a shaft slot.

In addition, any resulting bore and axis distance tolerances can be easily bridged if the elongate fastening element has a toothed slot, especially the heavy-duty spring pin.

In any case, the toothed slot also allows for better roundness, meaning that the elongate fastening element with toothed slot can also be used as a precise axle element.

Ultimately, this simplifies assembly and disassembly if designed appropriately, although disassembly in this case is more likely to be seen from the perspective of improved recycling.

In particular, this makes it possible to provide a precision spring pin with particularly high positioning accuracy and seating strength.

It is particularly advantageous if a heavy-duty spring pin with toothed slot is used, taking into account DIN EN ISO 8752 (2009-10).

The elongate fastening element can be provided with adequate resistance if the elongate fastening element has an outer diameter of 4.5 mm or more, preferably 5.5 mm or more, and more preferably 6 mm or more, in the unloaded state.

If the elongate fastening element, has an outer diameter of 9 mm or less, preferably 8 mm or less, and more preferably 6 mm or less, in the unloaded state, the mass or weight per fastening element, can be kept low.

It is advantageous if the elongate fastening element has a wall thickness of 0.8 mm or more, preferably of 1 mm or more, and more preferably of 1.2 mm or more, based on the total wall thickness of the elongate fastening element, in particular having a rolled body. This allows the elongate fastening element to be designed to have adequate strength.

If the elongate fastening element has a wall thickness of 2 mm or less, preferably 1.6 mm or less, and more preferably 1.2 mm or less, the elongate fastening element can be installed on the multi-part brake disk in a weight-optimized manner.

Furthermore, it is advantageous if the elongate fastening element has a length of 5 mm or more, preferably 8 mm or more, and preferably 10 mm or more. By selecting the length of the fastening element in this way, a sufficient penetration depth of the elongate fastening element into the body of the friction disk ring part can always be ensured, in particular almost independently of the thickness of the receiving pot part.

If the elongate fastening element has a length of 18 mm or less, preferably 15 mm or less and preferably 12 mm or less, the elongate fastening element can be advantageously designed with regard to its mass or weight, while still being able to ensure a sufficiently large friction surface between the fastening element and in particular the friction disk ring part.

In particular, a length of 10 mm plus/minus 0.25 mm is particularly advantageous in order to always be able to ensure a good operative connection between the receiving pot part and the friction disk ring part by means of the elongate fastening element, while at the same time the elongate fastening element protrudes by at least 2 mm on the inside of the receiving pot part.

To be able to easily insert the elongate fastening element into the through-hole of the receiving pot part and subsequently also into the hole of the friction disk ring part, in particular with regard to an automated insertion process, it is advantageous if the elongate fastening element has a chamfer at each of its ends, in particular with a chamfer length of 1.30 mm plus/minus 0.1 mm and a chamfer width of 0.40 mm or less.

In addition, it is advantageous if the at least one elongate fastening element has a mass of 2.2 g or less, preferably 1.8 g or less, and more preferably 1.2 g or less, since this can advantageously influence the total mass of the multi-part brake disk.

A still adequate strength can be achieved if the at least one elongate fastening element has a mass of 0.4 g or more, preferably 0.6 g or more, and more preferably 0.8 g or more.

It has been found that a mass of 1 g can be achieved particularly advantageously in terms of a very favorable weight (less rotating and oscillating masses) and still very good strength.

In particular, it is advantageous if the mass of a single elongate fastening element is dependent on the number of fastening elements. For example, the mass of each individual fastening element can be chosen to be lower the higher the number of fastening elements installed on the multi-part brake disk.

Preferably, the number of fastening elements on the multi-part brake disk is 18 pieces or less, preferably 15 pieces or less, and more preferably 13 pieces or less, and/or 8 pieces or more, preferably 10 pieces or more, and more preferably 12 pieces or more.

The fewer such fastening elements there are on the multi-part brake disk, the less mass or weight they add to the multi-part brake disk. At the same time, due to a smaller number of elongate fastening elements, the number of form-fitting connection points between the receiving pot part and the friction disk ring part is also reduced.

However, the more fastening elements there are, the more mass or weight these elongate fastening elements introduce into the multi-part brake disk, resulting in overall masses to be accelerated on a vehicle, particularly on the vehicle's wheel suspension.

It has been found that the number of 13 elongate fastening elements is particularly advantageous when the outer diameter of the friction disk ring part is approximately 323 mm, especially when the outer diameter of the receiving pot part is approximately 165 mm.

Moreover, the fastening element can be made of various materials.

The fastening element can be provided on the multi-part brake disk in a particularly cost-effective manner if the at least one elongate fastening element has a base body made of steel, in particular of a spring steel, such as 55Si7 tempered spring strip steel or the like, which also has particularly good inherent strength.

The fastening element can be very easily inserted through the through-hole of the receiving pot part and into the hole of the ring disk element if the at least one elongate fastening element has a cylindrical base body.

It is understood that the fastening element may also have other basic shapes, such as oval, rectangular, or the like, if this will be advantageous for an application.

An impact depth of the fastening element into the ring disk element can advantageously be limited if the at least one elongate fastening element has a head area and a shaft area. By means of the head area, the fastening element can advantageously be supported on the inside of the receiving pot part.

To be able to additionally ventilate, i.e., cool, the friction disk ring part in the area of the fastening element, it is advantageous if the at least one elongate fastening element has a ventilation opening for ventilating the friction disk ring part.

This makes it possible to carry additional heat out of the interior of the friction disk ring part through the fastening element or to carry additional air into the interior of the friction disk ring part.

A further advantageous embodiment provides that the at least one elongate fastening element and/or the receiving pot part have a surface coating, in particular a corrosion coating.

A suitable surface coating can provide protection against contact corrosion, for example, which generally provides improved protection for the multi-part brake disk during continuous operation.

In this case, a suitable surface coating can be provided only partially or entirely on the fastening element or on the receiving pot part. A partially arranged surface coating can further reduce manufacturing costs.

Another advantageous embodiment variant can be provided with regard to a loss prevention device, by means of which the friction disk ring part and the receiving pot part are secured to one another, in particular axially secured, whereby the loss prevention device has at least one friction and/or positive connection comprising at least one elongate fastening element.

As already mentioned above, this can additionally prevent undesirable axial displacement of the friction disk ring part and the receiving pot part.

It is also advantageous if the loss prevention device has an arrangement with a hardness gradient that decreases from the at least one elongate fastening element to the friction disk ring part. This allows the harder fastening part to advantageously penetrate and be fixed in the softer material of the friction disk ring part.

The functional components friction disk ring part and receiving pot part can be joined more advantageously if the receiving pot part has a cylindrical receiving area with a radially outwardly arranged cylindrical receiving surface for receiving the inside of the ring part.

Preferably, this creates a circular receiving seat for the friction disk ring part on the receiving pot part.

A further expedient embodiment variant can be created if the receiving pot part has a cylindrical receiving area with an outer diameter Da and the friction disk ring part has an inner diameter Di, whereby the ratio Da/Di is 1.01 or greater, preferably 1.02 or greater.

In this context, it is advantageous if the receiving pot part has a cylindrical receiving area with an outer diameter Dₐ, and the friction disk ring part has an inner diameter Di, whereby the ratio Dₐ/Dᵢ is 1.06 or less, preferably 1.05 or less.

Preferably, a diameter ratio da/di between 1.02 and 1.04 is aimed for.

The diameter ratios Dₐ/Dᵢ specified above enable a particularly robust operative connection to be realized between the friction disk ring part and the receiving pot part.

The dimensions relevant for the Dₐ/Dᵢ ratio refer to the largest inner diameter on the friction disk ring part and to the largest outer diameter on the receiving pot part. Tolerances regarding roundness deviations should be disregarded here.

In addition to the advantage of a particularly robust operative connection between the friction disk ring part and the receiving pot part, it has been shown that it is no less advantageous, if not more advantageous, if the diameter ratio Dₐ/Dᵢ is chosen to be significantly smaller than stated above.

In particular, this can significantly improve the assembly capability without critically neglecting the operative connection between the friction disk ring part and the receiving pot part with regard to production of the multi-part brake disk in question, in particular with regard to a still good torsion resistance of the functional components of the multi-part brake disk when they are joined together and in particular when the through-hole and the bore hole are made in the relevant functional components of the multi-part brake disk.

In this case, a preferential embodiment variant provides that the receiving pot part has a cylindrical receiving area with an outer diameter Dₐ and the friction disk ring part has an inner diameter Dᵢ, whereby the ratio Dₐ/Dᵢ is 1.00088 or greater, preferably 1,00089 or greater, or more preferably 1.0009 or greater.

The conditions chosen here allow for particularly good assembly of the friction disk ring part and the receiving pot part while still providing good resistance to torsion. The anti-torsion safety during assembly can advantageously be improved if the receiving pot part has a cylindrical receiving area with an outer diameter Dₐ and the friction disk ring part has an inner diameter Dᵢ, whereby the ratio Dₐ/Dᵢ is 1.001 or less, preferably 1.000999 or less, and more preferably 1.00091 or less. This guarantees a very close connection between the friction disk ring part and the receiving pot part

Furthermore, it is advantageous if the receiving pot part has a cylindrical receiving area with an outer diameter Dₐ and the friction disk ring part has an inner diameter Dᵢ, whereby the ratio Dₐ/Dᵢ is 1.00027 or less, preferably 1.00025 or less, and more preferably 1.00022 or less. This ensures a very close connection between the friction disk ring part and the receiving pot part.

If the receiving pot part has a cylindrical receiving area with an outer diameter Dₐ and the friction disk ring part has an inner diameter Dᵢ, whereby the ratio Dₐ/Dᵢ is 1.00019 or greater, preferably 1.0002 or greater, and more preferably 1.00021 or greater, adequate protection against torsion during assembly can still be ensured with good assembly capability.

Good assembly can still be ensured in particular if the ratio Dₐ/Dᵢ is 1.000909, whereby this ratio is based on a preferably largest outer diameter of 165.15 mm with regard to the receiving pot part and a preferably smallest inner diameter of 165 mm with regard to the friction disk ring part.

A still very good frictional connection and thus good torsion resistance of the friction disk ring part and the receiving pot part during assembly can be achieved if the ratio Da/Di is 0.999, whereby this ratio is based on a preferably smallest outer diameter of 165.05 mm with regard to the receiving pot part and a preferably largest inner diameter of 165.063 mm with regard to the friction disk ring part.

Advantageous press fit connections between the friction disk ring part and the receiving pot part can be provided if the friction disk ring part has an inner diameter Dᵢ of 164.9 mm or larger, preferably of 165 mm or larger, and more preferably of 165.05 mm or larger.

Likewise, advantageous press fit connections can be provided between the friction disk ring part and the receiving pot part if the friction disk ring part has an inner diameter Dᵢ of 166 mm or smaller, preferably of 165.063 mm or smaller, and more preferably of 165 mm or smaller.

A suitable counterpart for the advantageous press fit connections can be provided if the receiving pot part has an outer diameter Dᵢ of 164.95 mm or larger, preferably of 165 mm or larger, and more preferably of 165.05 mm or larger.

The selection of suitable press fit connections can advantageously be expanded if the receiving pot part has an outer diameter Dᵢ of 165.5 mm or smaller, preferably of 165.15 mm or smaller, and more preferably of 165 mm or smaller.

As already described above, the operative connection between the fastening element and the friction disk ring part can be achieved particularly easily if the hole drilled in the friction disk ring part is designed to be thread-free.

Furthermore, it is expedient if the bore hole drilled into the friction disk ring part has two different hole diameter ranges, whereby the hole drilled receives two different functional areas and can therefore also take on two functions.

In this context, it is particularly expedient if a larger hole diameter range of the bore hole is arranged radially further inward than a smaller hole diameter range of the bore hole. This allows the fastening element to be easily positioned in the radially outer hole diameter area.

In this respect, a preferential embodiment variant also provides that the at least one elongate fastening element is fastened to the friction disk ring part in the smaller hole diameter region arranged radially further outward.

If, on the one hand, the at least one elongate fastening element is arranged in the larger hole diameter area arranged radially further inward and, on the other hand, material of the receiving pot part can be introduced, the hole arranged in the friction disk ring part can structurally easily take on several different functions.

Furthermore, it is advantageous if an edge region of the through-hole of the receiving pot part can be displaced into the larger hole diameter region arranged radially further inward.

As a result, the bore hole in the friction disk ring part can, among other things, take on an additional function in addition to securing the fastening element, namely that of a receiving space or alternative space or introduction space for material areas or material residues, or the like of the receiving pot part.

It is therefore advantageous if the hole has an introduction space for introducing material from the receiving pot part.

Advantageously, the introduction space has a hole diameter that is larger than the outer diameter of the at least one fastening element which is arranged in the introduction space.

This leaves enough space in the insertion space between the outer surface of the fastening element and the inner wall of the hole for material to be introduced from the receiving pot part.

It is also particularly advantageous if the friction disk ring part has crack prevention holes that are arranged radially further outward at the respective end of the bore holes.

By means of such a crack prevention hole, any crack formation that may originate from a bore hole can be stopped so that a corresponding crack cannot spread further in the material of the friction disk ring part.

Preferably, the crack prevention holes run perpendicular to the bore holes.

To ensure that the at least one elongate fastening element is seated well and reliably within the bores, it is advantageous if the through-hole of the receiving pot part and the bore hole of the friction disk ring part each have a hole diameter L-Di and the at least one elongate fastening element has a pin diameter S-Da, whereby the ratio S-Dₐ/L-Dᵢ is 1.0551 or greater, preferably 1.0593 or greater, and more preferably 1.0612 or greater.

The at least one elongate fastening element can be advantageously introduced into the respective bore if the ratio S-Dₐ/L-Dᵢ is 1.0751 or less, preferably 1.0712 or less, and more preferably 1.0631 or less.

In this case, the present ratio S-Dₐ/L-Dᵢ can refer to both bores and the respective at least one elongate fastening element, or at least only one of the two bores and the respective at least one elongate fastening element.

Such a ratio S-Dₐ/L-Dᵢ can be designed particularly well if the at least one elongate fastening element has a pin diameter S-Dₐ of 6.4 mm, whereby one or both bores have a hole diameter L-Dᵢ of 6 mm. Here, the ratio S-Dₐ/L-Dᵢ has a value of exactly 1.06667.

If tolerances are taken into account, for example with regard to a smallest possible pin diameter S-Dₐ in combination with a largest possible hole diameter L-Dᵢ, it is advantageous if the through-hole of the receiving pot part and the hole of the friction disk ring part each have a hole diameter L-Dᵢ and the at least one elongate fastening element has a pin diameter S-Dₐ, whereby the ratio S-Dₐ/L-Dᵢ is 1.0345 or greater, preferably 1.0391 or greater, and more preferably 1.0419 or greater, and/or whereby the ratio S-Dₐ/L-Dᵢ is 1.0651 or less, preferably 1.0574 or less, and more preferably 1.0461 or less.

It has been found that an S-Dₐ/L-Dᵢ ratio of exactly 1.04575 is particularly advantageous. Such a ratio S-Dₐ/L-Dᵢ can be achieved, for example, by a pin diameter S-Dₐ of 6.4 mm and a hole diameter L-Dᵢ of 6.12 mm.

If the tolerances run in exactly the other direction, namely with a largest possible pin diameter S-Dₐ of approximately 6.7 mm in combination with a smallest possible hole diameter L-Dᵢ, approximately 6 mm, it is advantageous if the through-hole of the receiving pot part and the bore hole of the friction disk ring part each have a hole diameter L-Dᵢ and the at least one elongate fastening element has a pin diameter S-Dₐ, whereby the ratio S-Dₐ/L-Dᵢ is 1.0111 or greater, preferably 1.1011 or greater, and more preferably 1.1143 or greater, and/or whereby the ratio S-Dₐ/L-Dᵢ is 1.1199 or less, preferably 1.1187 or less, and more preferably 1.1177 or less.

For hole or pin dimensions in this regard, a ratio S-Dₐ/L-Dᵢ of exactly 1.11667 has proven to be particularly suitable.

The object of the invention is achieved according to a second aspect by a friction disk ring part for a multi-part brake disk with at least one thread-free hole bore which extends radially outward from the inner side of the ring part and which has different hole diameters.

As a result, a fastening element holding bore can be created in the friction disk ring part, which, in addition to holding the fastening element, can also fulfill at least one further function, as has already been described in detail above.

To achieve a comprehensive operative connection or securing in the sense of the invention, it is advantageous if a large number of holes are arranged in the circumferential direction of the inner side of the ring.

According to a third aspect of the invention, the object is achieved by a fastening element for a multi-part brake disk with an elongate base body, whereby the fastening element has at least one surface structure by means of which the base body can at least partially penetrate into the material of the friction disk ring part.

By means of this surface structure, a particularly close operative connection can be established between the fastening element and the friction disk ring part.

The insertion depth of the fastening element, which is preferably designed as a pin element, can be reliably limited if the elongate base body has a head area and a shaft area, whereby the head area and the shaft area have different outer diameters, in particular that the head area has a larger outer diameter than the shaft area.

According to a fourth aspect of the invention, the object is achieved by a method for producing a brake disk from several functional parts, in which a friction disk ring part with an inner diameter is arranged on a receiving surface arranged radially on the outside with an outer diameter Dₐ of a receiving cup part, in which the inner diameter Dᵢ and the outer diameter Da are selected with a ratio Dₐ/Dᵢ of 1.00088 or greater or with a ratio Dₐ/Dᵢ of 1.00027 or smaller before the friction disk ring part is arranged on the receiving surface, in which after the friction disk ring part has been arranged on the receiving surface, a through-hole and a bore hole are made in the friction disk ring part and in the receiving cup part with a single drilling process, and in which an elongate fastening element is introduced from radially further inside through the respective through-hole into the respective corresponding hole, whereby the elongate fastening element is fastened in the hole of the friction disk ring part at least partially with frictional engagement and/or positive engagement.

Through such a method, the friction disk ring part and the receiving pot part can advantageously be permanently connected to one another.

Furthermore, a method for producing a brake disk from several functional parts is also advantageous, in which a friction disk ring part is arranged on a receiving surface of a receiving pot part arranged radially on the outside in such a way that through-holes arranged on the receiving surface and bore holes arranged in the friction disk ring part are brought into overlap, and in which an elongate fastening element is introduced from radially further inside through the respective through-hole and into the respective corresponding hole, whereby the elongate fastening element is fastened in the hole of the friction disk ring part at least partially in a frictionally locking and/or positively locking manner.

Using the manufacturing process described here, a multi-part brake disk can be manufactured particularly easily.

In particular, the fastening element in the present case can be structurally fixed in a particularly simple manner by means of a frictional connection, in particular a press-fit connection, or a form-fitting connection.

The present manufacturing process can be further simplified if the elongate fastening element is hammered into the hole.

By driving the fastening element in this way, in particular into the friction disk ring part, there is no longer any need to screw in a fastening screw, as was previously the case.

The term “impacting” in the sense of the invention includes any method by means of which the fastening element can be introduced in particular into the friction disk ring part, such as by pushing it into the bore hole, pressing it in, or the like, in particular discontinuously or continuously.

For example, the fastening element can also be secured in the hole of the friction disk ring part in a particularly reliable manner, bypassing a threaded connection, if the elongate fastening element is secured in the bore hole by means of a grooved, in particular longitudinally grooved, jacket surface section of the fastening element.

In this respect, it is advantageous with regard to a method variant if the elongate fastening element penetrates into the material of the friction disk ring part outside the hole when the elongate fastening element is introduced into the hole.

In this case, the fastening element can actually cut into the material of the friction disk ring part beyond the inner wall of the hole in order to ensure an even more secure fit of the fastening element.

If the elongate fastening element is inserted into the bore hole with insertion forces of 4 kN or more, preferably 6 kN or more, and more preferably 8 kN, a secure fit between the fastening element and in particular the friction disk ring part can always be ensured.

The fastening element can be inserted with a reasonable amount of force if the elongate fastening element is inserted into the hole with insertion forces of 12 kN or less, preferably 10 kN or less, and more preferably 8 kN.

According to a fifth aspect of the invention, the stated object is achieved by using a pin element, in particular an at least partially longitudinally grooved pin element, for securing a friction disk ring part of a multi-part brake disk to a receiving pot part of the multi-part brake disk.

Using such a pin element, the production of a multi-part brake disk can be significantly simplified.

The following terminology should be explained:

It should be explicitly pointed out that, in the context of the present patent application, indefinite articles and indefinite numerical expressions such as “one . . . ,” “two . . . ,” etc., are generally to be understood as “at least one . . . ,” “at least two. ,” etc., unless it emerges from the context or the concrete text of a particular passage that only “exactly one . . . , “exactly two . . . ,” etc. are meant there. Furthermore, all numerical indications as well as indications of process parameters and/or device parameters are to be understood in the technical sense, i.e., as having the usual tolerances. In addition, the explicit indication of the restriction “at least” or “at a minimum” or similar should not give rise to the assumption that the simple use of “one,” i.e., without the indication of “at least” or similar, means “exactly one.”

The invention will be explained in more detail below using embodiments with reference to the drawing. Below,

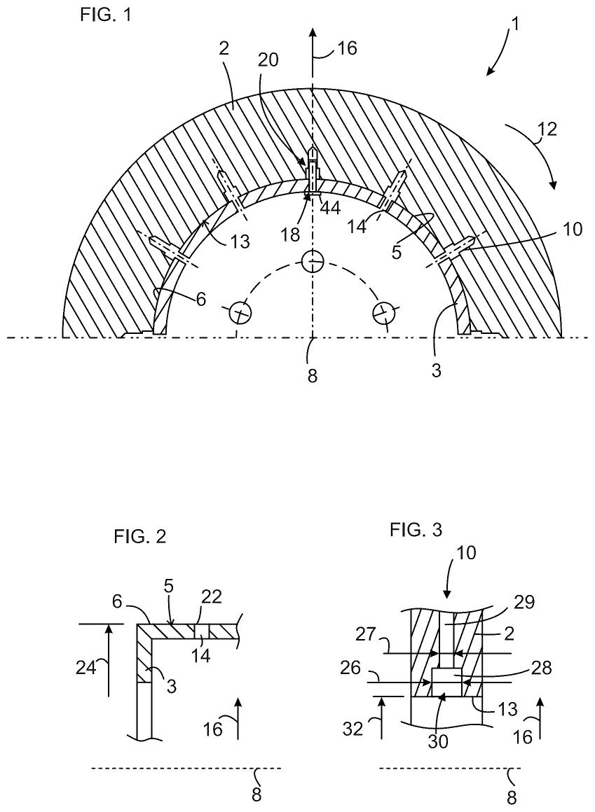

FIG. 1 shows schematically a sectional partial view of a possible embodiment of a multi-part brake disk with a receiving pot part and with a friction disk ring part, into which an elongate fastening element is inserted in order to additionally secure an operative connection between the receiving pot part and the friction disk ring part;

FIG. 2 shows a schematic partial sectional view of the receiving pot part of the multi-part brake disk from FIG. 1;

FIG. 3 shows schematically a partial sectional view of the friction disk ring part of the multi-part brake disk from FIG. 1;

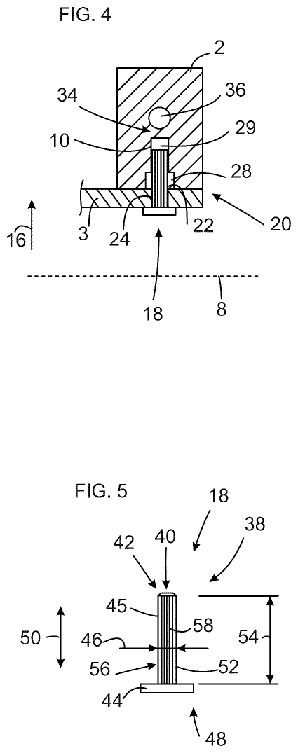

FIG. 4 shows a schematic sectional view of an operative connection of the elongate fastening element to the multi-part brake disk from FIG. 1;

FIG. 5 shows a schematic view of the elongate fastening element on the multi-part brake disk from FIG. 1;

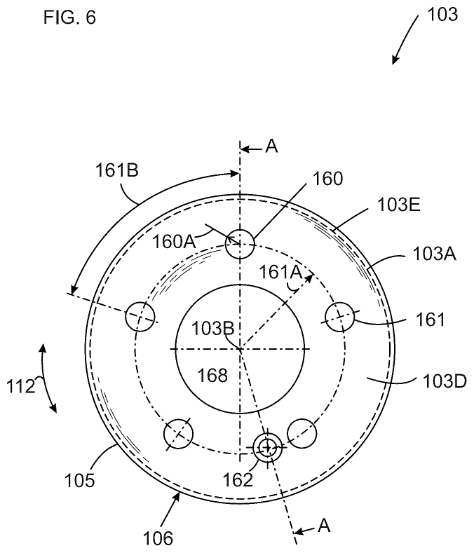

FIG. 6 shows a schematic view of another receiving pot part of an alternative multi-part brake disk;

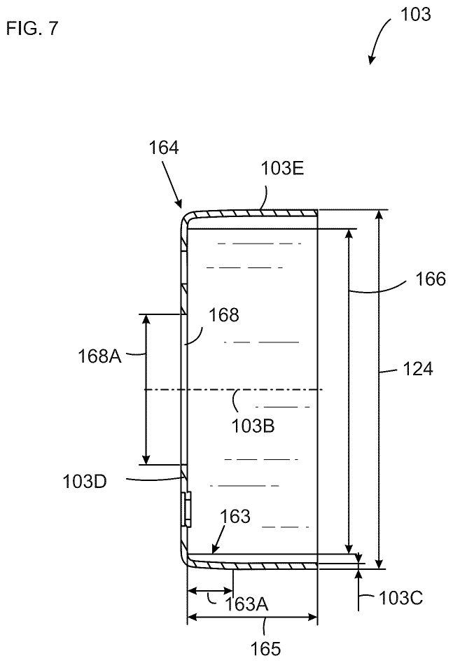

FIG. 7 shows schematically a sectional view of the further receiving pot part shown in FIG. 6 along the section line A-A;

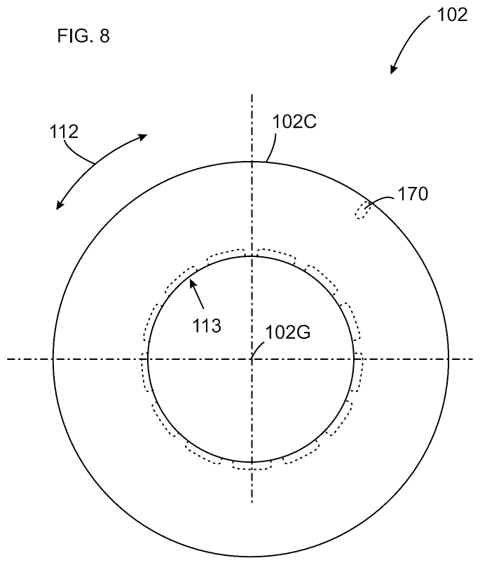

FIG. 8 shows a schematic view of another friction disk ring part of the alternative multi-part brake disk;

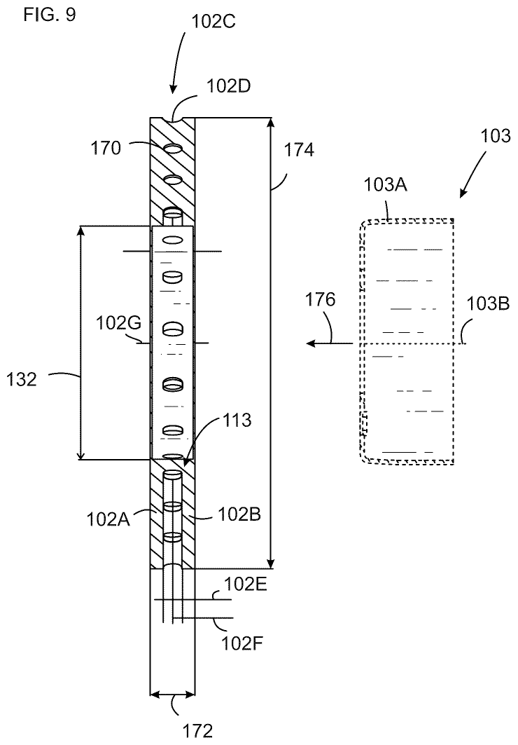

FIG. 9 shows a schematic sectional view of the further friction disk ring part shown in FIG. 8 along the section line F-F with the further receiving pot part from FIGS. 6 and 7 indicated to the right with the assembly direction;

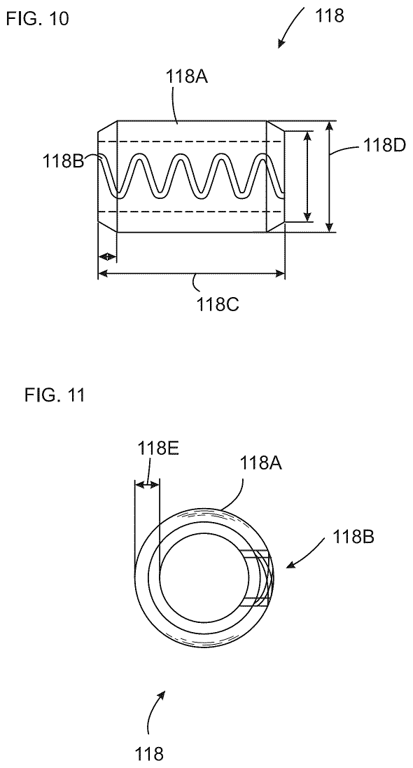

FIG. 10 shows schematically a side view of an elongate fastening element having a toothed slot;

FIG. 11 schematically shows a front view of the fastening element shown in FIG. 10;

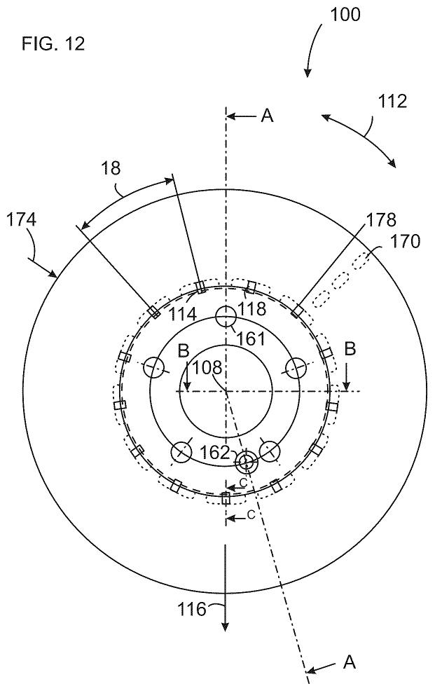

FIG. 12 schematically shows a partially sectioned assembly view of the alternative multi-part brake disk;

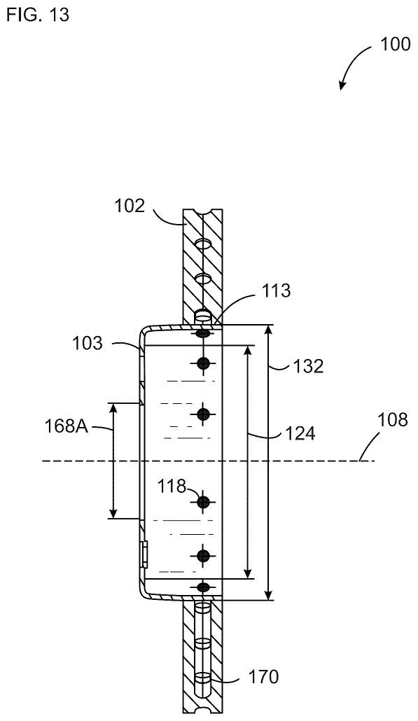

FIG. 13 shows schematically a sectional view along the section line A-A of the alternative multi-part brake disk shown in FIG. 12;

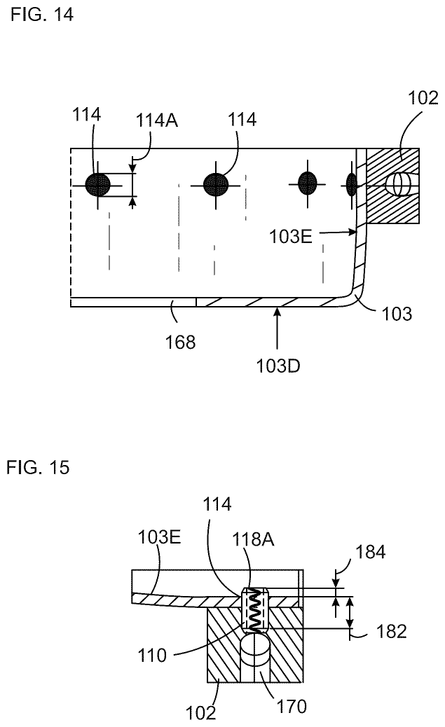

FIG. 14 shows schematically a sectional detailed view along the section line B-B of the alternative multi-part brake disk shown in FIG. 12;

FIG. 15 schematically shows a further sectional detailed view along the section line C-C of the alternative multi-part brake disk shown in FIG. 12; and

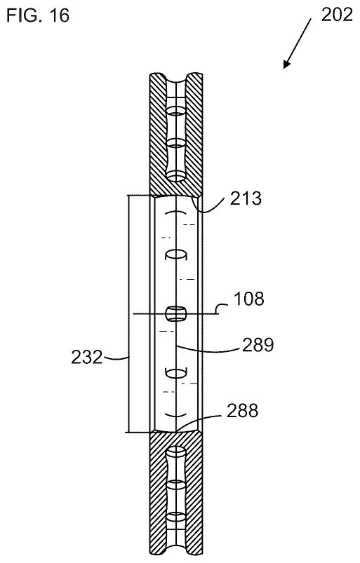

FIG. 16 schematically shows a sectional view of another friction disk ring part with a more concave receiving area for receiving, for example, the further receiving pot part from FIGS. 6 and 7.

The multi-part brake disk 1 shown in FIG. 1 consists essentially of a friction disk ring part 2 and a receiving pot part 3, whereby the friction disk ring part 2 is arranged on a cylindrical receiving surface 5 of the receiving pot part 3. The cylindrical receiving surface 5 is located on a cylindrical receiving area 6 of the receiving pot part 3.

The multi-part brake disk has a rotational axis 8.

While the friction disk ring part 2 has numerous holes 10 that are evenly distributed in the circumferential direction 12 of the multi-part brake disk 1, the receiving pot part 3 has corresponding through-holes 14 that overlap one another when the friction disk ring part 2 and the receiving pot part 3 are properly assembled.

The bore holes 10 extend in the friction disk ring part 2 from an inner side 13 of the ring part in radial directions 16 (shown only as an example) from radially further inward to radially further outward.

In other words, both the bore holes 10 and the through-holes 14 run transversely to the rotational axis 8 of the multi-part brake disk 1.

An elongate fastening element 18 is arranged in each bore hole 10 and in each through-hole 14, whereby each elongate fastening element 18 is driven from radially further inward to radially further outward, in particular into the respective bore hole 10, specifically through the associated through-hole 14.

The elongate fastening element 18 is frictionally secured at least to the friction disk ring part 2.

In this respect, a good frictional connection (not explicitly numbered), preferably as a press fit connection (also not further numbered), is produced between the elongate fastening element 18 and the friction disk ring part 2 by simply hammering the elongate fastening element 18 into the bore hole 10.

In particular, the multi-part brake disk 1 has, due to the existing frictional connection, a favorable loss prevention device 20, by means of which the friction disk ring part 2 and the receiving pot part 3 are held secured to one another, in particular axially secured to one another.

Preferably, the elongate fastening element 18 is optionally operatively connected to the friction disk ring part 2 by means of a form-fitting connection (not further numbered) in that the elongate fastening element 18 is at least partially interlocked with the friction disk ring part 2 within the bore hole 10.

Further details, in particular with regard to the friction disk ring part 2, the receiving pot part 3 and the elongate fastening element 18, are additionally shown in FIGS. 2 to 5.

The illustration in FIG. 2 shows the through-hole 14 in the receiving pot part 3 in more detail, whereby the through-hole 14 has an edge area 22 facing the friction disk ring part 2.

In this embodiment, the receiving pot part 3 has an outer diameter 22 with a value Da at its cylindrical receiving area 6.

In the illustration in FIG. 3, the area of the bore hole 10 in the friction disk ring part 2 is shown in more detail, whereby it is clearly visible that the bore hole 10 has different hole diameters 26 and 27, so that the bore hole 10 also has two different hole diameter areas 28 and 29.

As can be clearly seen in particular from the illustration in FIG. 4, the elongate fastening element 18 is fastened to the friction disk ring part 2 in the smaller hole diameter area 29 arranged radially further outward.

The larger hole diameter area 28 also provides an insertion space 30 at the hole 10, into which material areas of the receiving pot part 3 can deviate if necessary, should this be required for assembly reasons, in particular when driving the elongate fastening element 18 through the through-hole 14.

In this embodiment, the friction disk ring part 2 has an inner diameter 32 with a value Dᵢ on its ring part inner side 13.

In this embodiment, the mounting diameter ratio dₐ/dᵢ is 1.03 if possible.

As shown by the example in the illustration in FIG. 4, a crack prevention hole 36 is arranged on the friction disk ring part 2 at the end 34 of each bore hole 10.

The crack prevention holes 36 are not shown separately according to the illustration in FIG. 1, but only as an example in FIG. 4.

In the illustration in FIG. 5, the elongate fastening element 18 is shown in more detail.

In this embodiment, the elongate fastening element 18 is designed as a pin element 38, whereby the pin element 38 is designed as a hollow pin element (again, not separately numbered), whereby advantageous ventilation conditions>80% can be achieved at the position in the middle of the friction disk ring part 2.

In this respect, the elongate fastening element 18 has a ventilation opening 40 (not shown here) for ventilating the friction disk ring part 2, which is arranged through the entire elongate fastening element 18.

The elongate fastening element 18 has a cylindrical base body 42, so that it can be easily inserted into the likewise cylindrical bores 10 and 14.

Furthermore, the elongate fastening element 18 has a head area 44 and a shaft area 45.

The elongate fastening element 18 has an outer diameter 46 in the area of the shaft area 45 that is smaller than the larger hole diameter 26 of the bore hole 10 and smaller than the outer diameter 48 at the head area 44.

In any case, the elongate fastening element 18 has a longitudinal extension 50, and the elongate fastening element 18 has on its lateral surface 52 a lateral surface section 54 with a surface structure 56.

In this embodiment, the shaft area 45 has a directional surface structure 56.

The surface structure 56 thus has numerous grooves 58 in the longitudinal extension 50 of the elongate fastening element 18 that are arranged completely on the jacket surface 52, at least in the shaft area 45.

The grooves 58 create a toothing on the jacket surface 52.

According to the illustrations in FIGS. 6 and 7, a further embodiment of another receiving pot part 103 of an alternative multi-part brake disk 100 (see FIGS. 12 to 15) is shown before assembly with the associated further friction disk ring part 102 (see also FIGS. 8 and 9).

The further receiving pot part 103 does not yet have any through-holes 114 (see FIG. 12, numbered only as an example).

The further receiving pot part 103 consists of a sheet metal construction and thus has a sheet metal body 103A with a central axis 103B, whereby the central axis 103B coincides with the rotational axis 108 of the alternative multi-part brake disk 100. The sheet metal body 103A has a regular sheet metal wall thickness 103C of 2.5 mm.

Furthermore, the further receiving pot part 103 is characterized by a base area 103D and a collar area 103E, whereby the collar area 103E forms the cylindrical receiving surface 105 on which a friction disk ring part 102 of the alternative multi-part brake disk 100 is arranged.

The cylindrical receiving surface 105 is located on a cylindrical receiving area 106 of the receiving pot part 103.

The further receiving pot part 103 has five mounting holes 160, which serve for mounting the entire alternative multi-part brake disk 100 on a wheel hub (not shown here) of a motor vehicle (not shown).

The mounting holes 160 each have a diameter 160A of 15 mm.

The mounting holes 160 are located on a circle of holes 161 with a hole circle diameter 161A of 112 mm and a distribution dimension 161B of 72°.

The further receiving pot part 103 also has a positioning marking 162 for easier installation on the wheel hub.

Furthermore, in this further embodiment, the further receiving pot part 103 has an outer diameter 124 of exactly 165.1485 mm with respect to its cylindrical receiving area 106 or its cylindrical receiving surface 105.

At the cylindrical receiving area 106, the sheet metal body 103A has a maximum sheet metal wall thickness 103C of 3 mm.

The cylindrical receiving area 106, which runs concentrically around the central axis 103A in the circumferential direction 112 of the alternative multi-part brake disk 100, narrows further in the direction of the base area 103D with a constriction area 163 and then merges into this base area 103D with a 90°-angled corner area 164.

The constriction area 163 has a constriction length 163A of 21.11 mm, measured from the inside of the receiving pot part 103.

The base area 103D has a maximum base diameter 166 of 148 mm before the base area 103D merges into the corner area 164.

Radially further inward on the bottom area 103D of the further receiving pot part 103 there is a central opening 168 with an opening diameter 168A of 69 mm.

The collar area 103E of the further receiving pot part 103 has a collar height 165 between 45.5 mm and 59.5 mm, also measured from the inside of the receiving pot part 103.

According to the illustrations in FIGS. 8 and 9, a further embodiment of the further friction disk ring part 102 of the alternative multi-part brake disk 100 (cf. FIGS. 12 to 15) is shown before assembly.

The further friction disk ring part 102 does not yet have any bore holes 110 (see FIG. 12, numbered only as an example) corresponding to through-holes 114 of the further receiving pot part 103.

The further friction disk ring part 102 is designed as an internally ventilated friction disk ring part 102 and accordingly has numerous cooling openings 170 (numbered only as an example), some of which can also be designed differently.

The further friction disk ring part 102 has a first friction disk side 102A and a second friction disk side 102B, whereby the two friction disk sides 102A and 102B are spaced from one another at least on the outer side 102C of the friction disk ring part 102 by a circumferential groove 102D.

The circumferential groove 102D has a groove width 102E of 13.5 mm and the two friction disk sides 102A and 102B each have a side width 102F of 8.75 mm (numbered only as an example).

The further friction disk ring part 102 has a total thickness 172 of 31 mm and a total outer diameter 174 of 319 mm.

Furthermore, the further friction disk ring part 102 has a central axis 102G and, with respect to its inner ring part side 113, an inner diameter 132 of exactly 165 mm.

This results in a ratio Da/Di of 1.0009 with the previously described further receiving pot part 103 and its outer diameter 124 of exactly 165.1485 mm, at least in a state in which the further friction disk ring part 102 and the further receiving pot part 103 have not yet been joined together.

For example, the further receiving pot part 103 and the further friction disk ring part 102 are joined together according to the joining direction 176 to form the alternative multi-part brake disk 100, whereby an advantageous press fit connection is established between the further receiving pot part 103 and the further friction disk ring part 102 by means of the ratio Dₐ/Dᵢ of 1.0009.

For the proper assembly of the further friction disk ring part 102 and the further receiving pot part 103 to form the alternative multi-part brake disk 100, a pinning 178 (see FIG. 12) of the two functional components is provided; namely with numerous alternative elongate fastening elements 118, whereby such an alternative elongate fastening element 118 is shown according to the illustrations in FIGS. 10 and 11.

The alternative elongate fastening element 118 is designed as a chamfered heavy-duty spring pin 118A with a toothed slot 118B, as shown in FIGS. 10 and 11.

In this embodiment, the heavy-duty spring pin 118A has a pin length 118C of 10 mm and a pin diameter 118D of 6.4 mm.

As can be seen from FIG. 11, the heavy-duty spring pin 118A in this embodiment still has a total wall thickness 118E of 1.2 mm.

According to the illustrations in FIGS. 12 to 15, the alternative multi-part brake disk 100 is shown in an assembled state.

Here, the further friction disk ring part 102 is arranged on a cylindrical receiving surface 105 of the further receiving pot part 103, whereby the further receiving pot part 103 and the further friction disk ring part 102 can be arranged in such a rotationally fixed manner to one another by the press fit connection explained above that a large number of holes can be easily machined on the alternative multi-part brake disk 100 from radially further inward to radially further outward through the collar area 103E (through-holes 114) of the further receiving pot part 103 and into the further friction disk ring part 102 (bore holes 110).

In total, thirteen such bores (through bores 114 and hole bores 110) are provided on the alternative multi-part brake disk 100; specifically at a distribution 180 of exactly 27° 41′32″ measured in the circumferential direction 112.

The further friction disk ring part 102 has thirteen holes 110, whereby the further receiving pot part 103 has thirteen through-holes 114 that overlap with it.

The bore holes 110 extend in the friction disk ring part 102 from an inner side of the ring part 113 in radial directions 116 (shown only as an example) from radially further inward to radially further outward.

A heavy-duty spring pin 118A is arranged in each bore hole 110 and in each through-hole 114, whereby each heavy-duty spring pin 118A is inserted from radially further inward to radially further outward both into the respective through-hole 114 and into the respective bore 110.

The alternative multi-part brake disk has a rotation axis of 108.

According to the illustration in FIG. 14, a further detail of the alternative multi-part brake disk 100 is shown along the section line B-B (see FIG. 12), whereby the through-holes 114 in the collar area 103E of the receiving pot part 103 are again explicitly shown with regard to their bore hole diameters 114A of 6 mm.

According to the illustration in FIG. 15, another detail of the alternative multi-part brake disk 100 is shown along the section line C-C (see FIG. 12). It can be clearly seen here that the heavy-duty spring pin 118A is inserted into the functional components of the receiving pot part 103 and the friction disk ring part 102 with a total insertion depth 182 of at least 7.8 mm, whereby the heavy-duty spring pin 118A protrudes further radially inward by 2 mm on the inside of the collar area 103E with a projection 184.

According to the illustration in FIG. 16, another friction disk ring part 202 with a concave ring part inner side 213 is shown, whereby the other friction disk ring part 202 can be easily arranged on the further receiving pot part 103 (see in particular FIGS. 6 and 7).

The other friction disk ring part 202 has an inner diameter Dᵢ 232 of exactly 160 mm at the apex 288 of the concave ring part inner side 213, whereby the apex 288 is arranged at the center plane 289 of the other friction disk ring part 202.

With the inner diameter Dᵢ 232 of exactly 160 mm on the other friction disk ring part 202 and the outer diameter Dₐ 124 of exactly 165.1485 mm of the further receiving pot part 103, this configuration results in a ratio Da/Di of 1.0321, at least in a state in which the further friction disk ring part 102 and the further receiving pot part 103 are not yet joined together.

Even if the inner diameter Dᵢ 232 were to be 160.5 mm due to tolerances, this would still result in an advantageous Dₐ/Dᵢ ratio of 0.9978 in relation to the outer diameter Dₐ 124 of exactly 165.1485 mm of the further receiving pot part 103, whereby a downwardly scattering inner diameter Dᵢ 232 of 159 mm would result in a Dₐ/Dᵢ ratio of 1.0386.

The embodiments shown here represent only first examples of the present invention and must therefore not be understood as limiting. Alternative embodiments contemplated by qualified experts are equally included within the scope of the present invention.

### LIST OF REFERENCE SYMBOLS USED

1 Multi-part brake disk
2 Friction disk ring part
3 Receiving pot part
5 Cylindrical receiving surface
6 Cylindrical receiving area
8 Rotational axis
10 Bore holes
12 Circumferential direction
13 Inner side of ring part
14 through-holes
16 Radial directions or radially outward
18 Elongate fastening elements
20 Loss protection device
22 Edge area
24 External diameter
26 First hole diameter
27 Second hole diameter
28 First hole diameter area
29 Second hole diameter area
30 Insertion area
32 Internal diameter
34 End
36 Crack prevention holes
38 Pin element
40 Ventilation opening
42 Base body or cylindrical base body
44 Head area
45 Shaft area
46 Shaft external diameter
48 Head external diameter
50 Longitudinal extension or longitudinal direction
52 Jacket surface
54 Jacket surface section
56 Surface structure
58 Grooves or corrugations
100 Alternative multi-part brake disk
102 Further friction disk ring part
102A First friction disk ring side
102B Second friction disk ring side
102C External side
102D Circumferential groove
102E Groove width
102F Side width
102G Central axis
103 Further receiving pot part
103A Sheet metal body
103B Central axis
103C Sheet metal wall thickness
103D Floor area
103E Collar area
105 Cylindrical receiving surface
106 Cylindrical receiving area
108 Rotational axis
110 Bore holes
112 Circumferential direction
113 Inner side of ring part
114 through-holes
114A Hole diameter
116 Radial directions or radially outward
118 Elongate fastening elements
118A Heavy-duty spring pin
118B Toothed slot
118C Pin length
118D Pin diameter
118E Total wall thickness
124 External diameter
132 Internal diameter
160 Assembly holes
160A Diameter
161 Hole circle
161A Hole circle diameter
161B Partition dimension
162 Mark for positioning
163 Constriction area
163A Constriction length
164 Corner area
165 Collar height
166 Floor diameter
168 Central opening
168A Opening diameter
170 Cooling holes
172 Total thickness
174 Total external diameter
176 Assembly direction
178 Pinning
180 Partition
182 Insertion depth
184 Protrusion

1-44. (canceled)

45. A multi-part brake disk,
in particular a lightweight brake disk,
with a friction disk ring part and with a receiving pot part,
in which the friction disk ring part is arranged radially outside on the receiving pot part torque-proof,
in which the friction disk ring part and the receiving pot part are additionally operatively connected to one another by means of at least one elongate fastening element, whereby the at least one elongate fastening element is arranged in a through-hole of the receiving pot part and in a bore hole of the friction disk ring part,
wherein
the at least one elongate fastening element is arranged merely inserted into both the receiving pot part and the friction disk ring part, and
the at least one elongate fastening element is arranged in a frictionally locked manner in the friction disk ring part,
wherein, optionally, the at least one elongate fastening element and/or the receiving pot part can have a surface coating, in particular a corrosion coating.

46. A multi-part brake disk according to claim 45, wherein
the at least one elongate fastening element is arranged in the friction disk ring part by means of a press fit connection
and/or
the at least one elongate fastening element is arranged form-fitting in the friction disk ring part, whereby in particular the at least one elongate fastening element is arranged form-fitting in the friction disk ring part by means of a form-fitting connection.

47. Multi-part brake disc according to claim 45, wherein the at least one elongate fastening element
has at least partially a surface structure on its jacket surface, preferably a directed surface structure, wherein in particular the surface structure comprises grooves, scores or the like, and wherein in particular the surface structure extends directed in the longitudinal direction of the elongate fastening element;
and/or
is a pin element (36), in particular a longitudinally slotted pin element (36)
and/or
is a hollow pin element, in particular a heavy-duty spring pin, whereby the elongate fastening element has a toothed slot.

48. A multi-part brake disk according to claim 45, wherein the at least one elongate fastening element in the unloaded state has
an outer diameter of 4.5 mm or greater,
preferably 5.5 mm or greater,
and more preferably 6 mm or greater,
and/or
an outer diameter of 9 mm or less,
preferably 8 mm or less,
and more preferably 6 mm or less
and/or
a length of 5 mm or longer, preferably 8 mm or longer, and more preferably 10 mm or longer, and/or has a length of 18 mm or less, preferably 15 mm or less, and more preferably 12 mm or less
and/or
a mass of 2.2 g or less, preferably 1.8 g or less, and more preferably 1.2 g or less, and/or has a mass of 0.4 g or greater, preferably 0.6 g or greater, and more preferably 0.8 g or greater.

49. A multi-part brake disk according to claim 45, characterized in that the at least one elongate fastening element
has a base body made of steel
and/or
has a cylindrical base body
and/or
has a head area and a shaft area.

50. A multi-part brake disk according to claim 45, characterized in that the at least one elongate fastening element has a ventilation opening or ventilating the friction disk ring part.

51. A multi-part brake disk according to claim 45, characterized by a loss prevention device, by means of which the friction disk ring part and the receiving pot part are secured to one another, in particular axially secured, whereby the loss prevention device has at least one friction and/or form-fitting connection comprising at least one elongate fastening element,
wherein, optionally, the loss prevention device can have an arrangement with a hardness gradient that slopes down from the at least one elongate fastening element to the friction disk ring part.

52. A multi-part brake disk according to claim 45, characterized in that the receiving pot part has a cylindrical receiving area with a cylindrical receiving surface arranged radially outward for receiving the ring part inner side.

53. A multi-part brake disk according to claim 45, characterized in that the receiving pot part has a cylindrical receiving area with an outer diameter Da and the friction disk ring part has an inner diameter Dᵢ,
wherein the ratio Dₐ/Dᵢ is 1.01 or greater, preferably 1.02 or greater.

54. A multi-part brake disk according to claim 45, characterized in that the receiving pot part has a cylindrical receiving area with an outer diameter Da and the friction disk ring part has an inner diameter Dᵢ,
wherein the ratio Dₐ/Dᵢ is 1.06 or less, preferably 1.05 or less.

55. A multi-part brake disk according to claim 45, characterized in that the receiving pot part has a cylindrical receiving area with an outer diameter Dₐ and the friction disk ring part has an inner diameter Dᵢ,
wherein the ratio Dₐ/Dᵢ is 1.00088 or greater, preferably 1.00089 or greater, and more preferably 1.0009 or greater.

56. A multi-part brake disk according to claim 45, characterized in that the receiving pot part has a cylindrical receiving area with an outer diameter Dₐ and the friction disk ring part has an inner diameter Dᵢ,
wherein the ratio Dₐ/Dᵢ is 1.00027 or greater, preferably 1.00025 or smaller, and more preferably 1.00022 or greater.

57. A multi-part brake disk according to claim 45, characterized in that the friction disk ring part has an inner diameter Dᵢ,
of 164.9 mm or larger, preferably 165 mm or larger, and more preferably 165.05 mm or larger
and/or
of 166 mm or smaller, preferably of 165.063 mm or smaller, and more preferably of 165 mm or smaller.

58. A multi-part brake disk according to claim 45, characterized in that the receiving pot part has an outer diameter Da
of 164.95 mm or larger, preferably 165 mm or larger, and more preferably 165.05 mm or larger
and/or
of 165.5 mm or smaller, preferably of 165.15 mm or smaller, and more preferably of 165 mm or smaller.

59. A multi-part brake disk according to claim 45, characterized in that the bore hole (10; 110) made in the friction disk ring part (2; 102; 202) is thread-free.

60. A multi-part brake disk according to claim 45, characterized in that the bore hole made in the friction disk ring part has two hole diameter ranges that are different from one another, whereby in particular a larger hole diameter range of the bore hole is arranged radially further inward than a smaller hole diameter range of the bore hole, wherein, optionally,
the smaller hole diameter area arranged radially further outward, the at least one elongate fastening element is fastened to the friction disk ring part and/or
in the larger hole diameter area arranged radially further inward, on the one hand the at least one elongate fastening element is arranged and on the other hand material of the receiving pot part (can be introduced
and/or
an edge area of the through-hole of the receiving pot part can be displaced into the larger hole diameter region arranged radially further inward.

61. A multi-part brake disk according to claim 45, characterized in that the bore hole has an introduction space for introducing material of the receiving pot part, whereby in particular the introduction space has a hole diameter that is larger than the outer diameter of the at least one fastening element, which is arranged in the introduction space.

62. A multi-part brake disk according to claim 45, characterized in that the friction disk ring part has crack prevention holes that are arranged radially further outward at the respective end of the hole bores.

63. A multi-part brake disk according to claim 45, characterized in that the through-hole of the receiving pot part and the bore hole of the friction disk ring part each have a hole diameter L-Dᵢ and the at least one elongate fastening element has a pin diameter S-Dₐ, whereby the ratio S-Dₐ/L-Dᵢ is 1.0551 or greater, preferably 1.0593 or greater, and more preferably 1.0612 or greater, and/or whereby the ratio S-Dₐ/L-Dᵢ is 1.0751 or less, preferably 1.0712 or less, and more preferably 1.0631 or less.

64. A multi-part brake disk according to claim 45, characterized in that the through-hole of the receiving pot part and the bore hole of the friction disk ring part each have a hole diameter L-Dᵢ and the at least one elongate fastening element has a pin diameter S-Dₐ, whereby the ratio S-Dₐ/L-Dᵢ is 1.0345 or greater, preferably 1.0391 or greater, and more preferably 1.0419 or greater, and/or whereby the ratio S-Dₐ/L-Dᵢ is 1.0651 or less, preferably 1.0574 or less, and more preferably 1.0461 or less.

65. A multi-part brake disk according to claim 45, characterized in that the through-hole of the receiving pot part and the bore hole of the friction disk ring part each have a hole diameter L-Dᵢ and the at least one elongate fastening element has a pin diameter S-Dₐ, whereby the ratio S-Dₐ/L-Dᵢ is 1.0111 or greater, preferably 1.1011 or greater, and more preferably 1.1143 or greater, and/or whereby the ratio S-Dₐ/L-Dᵢ is 1.1199 or less, preferably 1.1187 or less, and more preferably 1.1177 or less.

66. Friction disk ring part for a multi-part brake disk,
for a multi-part brake disk according to claim 45,
with at least one thread-free hole bore which extends from the ring part inner side radially further outward and which has different hole diameters,
wherein numerous bore holes are arranged in the circumferential direction of the ring inner side.

67. A fastening element for a multi-part brake disk,
in particular for a multi-part brake disk according to claim 45,
with an elongate base body, whereby the fastening element has at least one surface structure by means of which the base body can at least partially penetrate into the material of the friction disk ring part.

68. A method for producing a brake disk from several functional parts,
in which a friction disk ring part with an inner diameter Dᵢ is arranged on a radially outer receiving surface with an outer diameter Dₐ of a receiving pot part,
in which the inner diameter Dᵢ and the outer diameter Dₐ are selected
with a ratio Dₐ/Dᵢ of 1.00088 or greater
or
with a ratio Dₐ/Dᵢ of 1.00027 or less
before the friction disk ring part is arranged on the receiving surface, on which,
after arranging the friction disk ring part on the receiving surface,
a through-hole and a bore hole are each made in the friction disk ring part and in the receiving pot part in a single drilling process,
and in which an elongate fastening element is introduced from radially further inside through the respective through-hole into the respective corresponding hole,
whereby the elongate fastening element is fastened in the bore hole of the friction disk ring part at least partially by frictional engagement and/or by positive engagement.

69. A procedure according to claim 68, characterized in that the elongate fastening element is hammered into the bore hole.

70. A procedure according to claim 68, characterized in that the elongate fastening element is fixed in the hole by means of a grooved, in particular longitudinally grooved, jacket surface section of the elongate fastening element.

71. A procedure according to one claim 68, characterized in that the elongate fastening element penetrates into the material of the friction disk ring part outside the bore hole when the elongate fastening element is introduced into the bore hole.

72. A procedure according to claim 68, characterized in that the elongate fastening element is introduced into the bore hole with an insertion force of
4 kN or more, preferably 6 kN or more, and more preferably 8 KN
and/or
12 kN or more, preferably 10 kN or more, and more preferably 8 kN.
